(19) United States
(12) Patent Application Publication
(10) Pub. No.: US 2016/0198021 A1
(43) Pub. Date: Jul. 7, 2016

(54) DYNAMIC PROTOCOL SWITCHING

(71) Applicant: Citrix Systems, Inc., Fort Lauderdale, FL (US)

(72) Inventor: Scott MOONEY, Coral Springs, FL (US)

(21) Appl. No.: 14/986,467

(22) Filed: Dec. 31, 2015

Related U.S. Application Data
(60) Provisional application No. 62/099,394, filed on Jan. 2, 2015.

(51) Int. Cl. H04L 29/06

(52) U.S. Cl. CPC H04L 69/08; H04L 69/28

(57) ABSTRACT

Approaches for dynamically switching between network protocols are described. Networks may utilize a Transmission Control Protocol (TCP) or a protocol based on a User Datagram Protocol (UDP), such as the Lightweight Framebuffer Protocol (LFP). A device communicating over TCP can simultaneously monitor characteristics of a network associated with a UDP-based protocol. The device can switch from TCP to a UDP-based protocol based on the monitored characteristics. The monitored characteristics can include information associated with available bandwidth, latency, and/or packet loss.

### CROSS REFERENCE TO RELATED APPLICATION

This application claims priority to U.S. Provisional Patent Application No. 62/099,394, which was filed on Jan. 2, 2015, the disclosure of which is expressly incorporated herein by reference in its entirety.

### BACKGROUND

The Transmission Control Protocol (TCP) is one of the core protocols of the Internet protocol suite, and is so common that the entire suite is often called “TCP/IP.” TCP resides at the transport layer of the open systems interconnection (OSI) model, and provides reliable, ordered, and error-checked delivery of a stream of data between programs running on network devices. These network devices can be connected to a local area network (LAN), a wide area network (WAN) such as the Internet, an intranet, etc. TCP uses a sequence number to identify each byte of data. The sequence number identifies the order of the bytes sent from each computer so that the data can be reconstructed in order, regardless of any fragmentation, disordering, or packet loss that can occur during transmission. TCP uses a cumulative acknowledgment scheme, where the receiver sends an acknowledgment signifying that the receiver has received all data preceding the acknowledged sequence number. Acknowledgments for data sent, or lack of acknowledgments, are used by senders to infer network conditions between the TCP sender and receiver. Coupled with timers, TCP senders can employ a retransmission timeout and resend data in response to packet loss.

The User Datagram Protocol (UDP) is also one of the core members of the Internet protocol suite. UDP uses a simple connectionless transmission model. Connectionless communication is a data transmission method used in packet switching networks in which each data unit is individually addressed and routed based on information carried in each unit, rather than in the setup information of a prearranged, fixed data channel as in connection-oriented communication such as TCP. UDP has no handshaking dialogues as with TCP, and thus exposes any unreliability of the underlying network protocol to a user's program. With UDP, there is no guarantee of delivery, ordering, or duplicate protection.

### BRIEF DESCRIPTION OF THE DRAWINGS

Reference will now be made to the accompanying drawings showing example embodiments of this disclosure. In the drawings:

FIG. 1 is a block diagram of an exemplary network environment, consistent with embodiments of the present disclosure.

FIGS. 2A-2B are block diagrams of an exemplary computing device, consistent with embodiments of the present disclosure.

FIG. 3 is a block diagram of an exemplary computing device, consistent with embodiments of the present disclosure.

FIG. 4 is a flowchart representing an exemplary method of dynamic protocol switching, consistent with embodiments of the present disclosure.

FIG. 5 is a flowchart representing an exemplary method of dynamic protocol switching, consistent with embodiments of the present disclosure.

### DETAILED DESCRIPTION

Reference will now be made in detail to the exemplary embodiments implemented according to the present disclosure, the examples of which are illustrated in the accompanying drawings. Wherever possible, the same reference numbers will be used throughout the drawings to refer to the same or like parts. Further, to the extent that the terms “transmit” and “provide” are used throughout the present disclosure and claims, it should be appreciated that unless otherwise specified herein, the terms can be used to indicate the direct transfer or availability of data (e.g., a packet) to another device, or the indirect transfer or availability of data to another device. For instance, if a client device transmitted or provided a packet to a server, then (1) that client device could have transmitted or provided that packet directly to that server, or (2) that client device could have transmitted or provided that packet to one or more intervening devices, such that the packet is received by the server after being transmitted or provided to the one or more intervening devices. It should be noted that herein, the terms device and appliance can be used interchangeably.

As described above, TCP and UDP are core components of the Internet protocol suite. Each of these protocols has its advantages. For example, TCP provides a reliable connection wherein a receiving device sends acknowledgements to a sending device. UDP does not typically provide a reliable connection as no acknowledgements are returned to the sending device by the receiving device. However, some UDP-based protocols, such as the Lightweight Framebuffer Protocol (LFP), provide increased reliability without ordering data and tracking connections as with TCP. LFP was created by Framehawk, Inc. of San Francisco, Calif. LFP is described in U.S. patent application Ser. No. 12/784,454, filed May 20, 2010, entitled, “Methods for Interfacing with a Virtualized Computing Service over a Network using a Lightweight Client,” U.S. patent application Ser. No. 12/784,468, filed on May 20, 2010, entitled “Systems and Algorithm for Interfacing with a Virtualized Computing Service over a Network using a Lightweight Client,” and U.S. patent application Ser. No. 13/358,494, filed on Jan. 25, 2012, entitled “Methods and System for Enabling Communication of Identity Information During Online Transaction,” which are incorporated herein by reference in their entirety. LFP can sit on a server, in the cloud, etc., and can operate over low-bandwidth networks with highly variable latency, loss, and jitter. LFP uses UDP for high-speed access, and has sophisticated security and reliability capabilities built in.

Independent Computing Architecture (ICA) is a proprietary protocol for an application server system, designed by Citrix Systems™. Current ICA-based protocols do not always work efficiently on networks with significant packet loss, and can have reduced performance over long latencies due to being built on top of a TCP network. Key challenges associated with ICA are network latency and performance. For example, a graphically intensive application (as most are when presented using a GUI) being served over a slow or bandwidth-restricted network connection requires considerable compression and optimization to render the application usable by the client. The client machine can use a different platform, and may not have the same GUI routines available locally. In such a case, a server may need to send actual bitmap data over a connection. Depending on a client's capabilities, servers may also off-load part of the graphical processing to a client, e.g., to render multimedia content. Protocols based on UDP can perform better with these types of applications/on these types of networks, but aren't as efficient in server resource usage.

Embodiments presented herein describe one or more devices that can dynamically switch a network connection from one protocol to another over a remote display protocol (such as ICA). The switch can be seamless (e.g., without the user knowing, without causing a particular amount of delay, during a session). In some embodiments described herein, networks are capable of employing both TCP (also referred to as a TCP network), and UDP-based protocols. For example, a device can transmit data over TCP, and switch to a UDP-based protocol such as LFP if characteristics related to a network meet particular criteria or a particular threshold condition. Similarly, a device can transmit data over a UDP-based protocol, and switch to TCP if characteristics associated with a network meet particular criteria or a particular threshold condition. This switch can occur at various locations in various networks.

In various embodiments, a TCP protocol and/or a UDP-based protocol can be utilized to determine information about a network. The information can be used as input for a device that determines whether or not to change protocols. Herein, information can also be referred to using the terms characteristics, attributes, properties, statistics, conditions, etc. In some embodiments, in response to a UDP-based protocol being utilized, information can be gathered comprising the true conditions of a network (e.g., wherein network conditions are not affected by TCP flow control and other reliability mechanisms). It should be noted that in order to determine when to switch from one protocol to another, a device can monitor network conditions and provide information about the network conditions.

Various approaches herein describe networks capable of switching between protocols based on when network conditions improve or degrade, or on a variety of other factors. In some embodiments, a client can specify a preference for a particular protocol type. This preference can be based on a perceived user experience. Similarly, a device may determine whether to switch between protocols based at least in part on conditions previously associated with a particular network. In various embodiments, a device can provide policies that reference which protocol type to use based on standard policy criteria, or thresholds can be set for various network conditions such as loss, latency, and bandwidth. Further, a user can dynamically switch protocol types within a session. Any other conditions can be factored into a decision on when to switch protocol types, such as server load and bandwidth usage aside from a user experience.

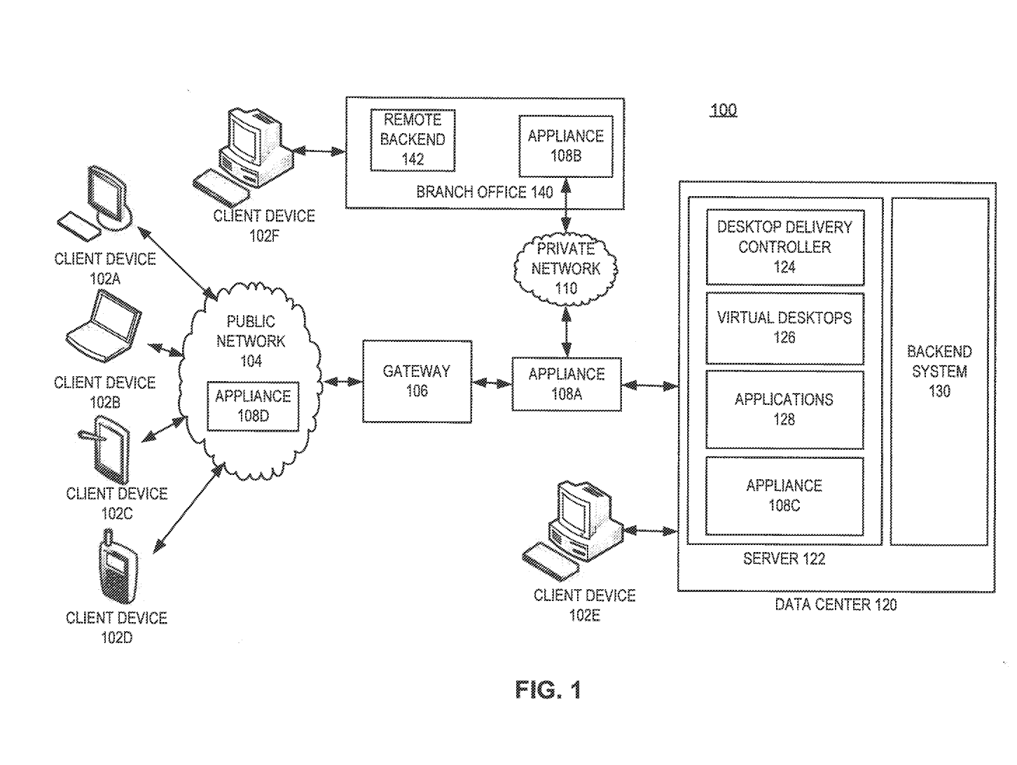

Various devices can be used to implement dynamic protocol switching. For example, FIG. 1 is a block diagram of an exemplary network environment 100. While exemplary network environment 100 is directed to a virtual network environment, it is appreciated that network environment 100 can be any type of network that communicates using packets. Network environment 100 can include one or more client devices 102, a public network 104, a gateway 106, an appliance 108 that can (or cause a device to) switch protocols, a private network 110, a data center 120, and a branch office 140.

One or more client devices 102 are devices that can acquire remote services from data center 120 through various means. Client devices 102 can communicate with data center 120 either directly (e.g., client device 102E) or indirectly through a public network 104 (e.g., client devices 102A-D) or a private network 110 (e.g., client device 102F). While client devices 102 are portrayed as a computer (e.g., client devices 102A, 102E, and 102F), a laptop (e.g., client device 102B), a tablet (e.g., client device 102C), and a mobile smart phone (e.g., client device 102D), it is appreciated that client device 102 could be any type of device that can send and receive signals to and from data center 120, such as a wearable computer.

Gateway 106 is a physical device or is software that is part of a physical device that interfaces between a public network 104 and an appliance 108A that can switch what type of protocol it will transmit data with. Gateway 106, for example, can be a server, a router, a host, or a proxy server. In some embodiments, gateway 106 can include or be coupled to a firewall separating gateway 106 from public network 104 (e.g., Internet). Gateway 106 has the ability to modify signals received from client device 102 into signals that appliance 108 and/or data center 120 can understand and vice versa.

One or more appliances 108 are module and/or devices can, or can cause, itself or one or more devices to switch from transmitting using TCP to a UDP-based protocol or vice-versa. In some embodiments, appliance 108 can be virtual. Appliances 108 can be located at a variety of locations. For example, appliance 108 can be located in a server (e.g., appliance 108C), in between a server/data center and a gateway (e.g., 108A), at a location connected to a device via a private network (e.g., appliance 108B), and/or in a public network, cloud, or other multi-tenant environment (e.g., appliance 108D). In some embodiments, the functionality of gateway 106 and appliance 108 can be located in a single physical device. It is further contemplated that such an appliance 108 can be located on a client device 102 (or a proxy device such as a proxy server). In any case, one or more appliances 108 may work alone or in conjunction with one or more other appliances 108.

Data center 120 is a central repository, either physical or virtual, for the storage, management, and dissemination of data and information pertaining to a particular public or private entity. Data center 120 can be used to house computer systems and associated components, such as one or more physical servers, virtual servers, and storage systems. Data center 120 can include, among other things, one or more servers (e.g., server 122) and a backend system 130. In some embodiments data center 120 can include gateway 106, appliance 108, or a combination of both.

Server 122 is an entity that can be represented by any electronic addressable format, and can exist as a single entity or a member of a server farm. Server 122 can be a physical server or a virtual server. In some embodiments, server 122 can include a hardware layer, an operating system, and a hypervisor creating or managing one or more virtual machines. Server 122 provides one or more services to an endpoint. These services include providing one or more applications 128 to one or more endpoints (e.g., client devices 102A-F or branch office 140). For example, applications 128 can include Windows™-based applications and computing resources.

In some embodiments, the services include providing one or more virtual desktops 126 that can provide one or more applications 128. Virtual desktops 126 can include hosted shared desktops allowing multiple users to access a single shared Remote Desktop Services desktop, virtual desktop infrastructure desktops allowing each user to have their own virtual machine, streaming disk images, a local virtual machine, individual applications (e.g., one or more applications 128), or a combination thereof.

Backend system 130 is a single or multiple instances of computer networking hardware, appliances, or servers in a server farm or a bank of servers and interfaces directly or indirectly with server 122. For example, backend system 130 can include Microsoft™ Active Directory, which can provide a number of network services, including lightweight directory access protocol (LDAP) directory services, Kerberos-based authentication, domain name system (DNS) based naming and other network information, and synchronization of directory updates amongst several servers. Backend system 130 can also include, among other things, an Oracle backend server, a SQL Server backend, and/or a dynamic host configuration protocol (DHCP). Backend system 130 can provide data, services, or a combination of both to data center 120, which can then provide that information via varying forms to client devices 102 or branch office 140.

Branch office 140 is part of a local area network that is part of the WAN having data center 120. Branch office 140 can include, among other things, appliance 108B and remote backend 142. In some embodiments, appliance 108B can sit between branch office 140 and private network 110. As stated above, appliance 108B can work with appliance 108A, etc. Remote backend 142 can be set up in similar manner as backend system 130 of data center 120. Client device 102F can be located on-site to branch office 140 or can be located remotely from branch office 140.

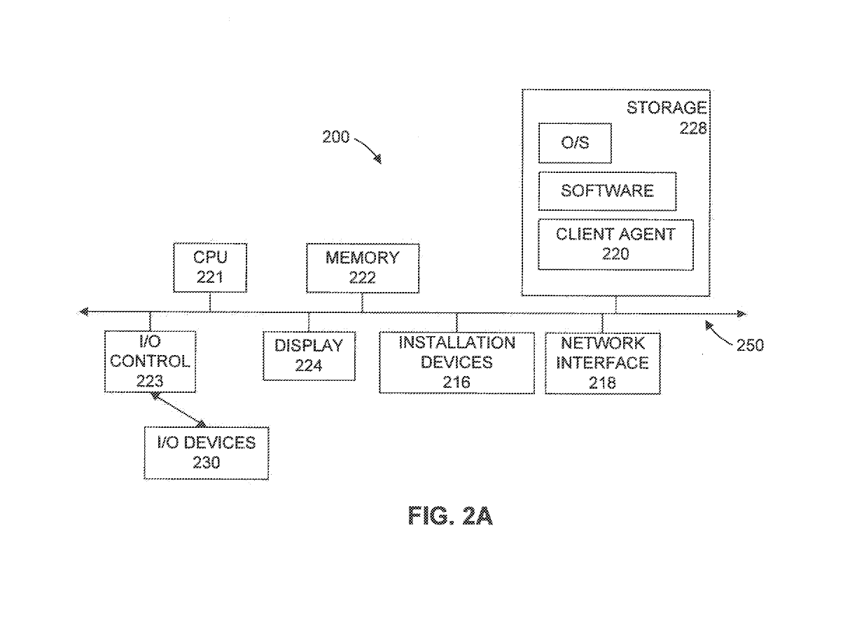

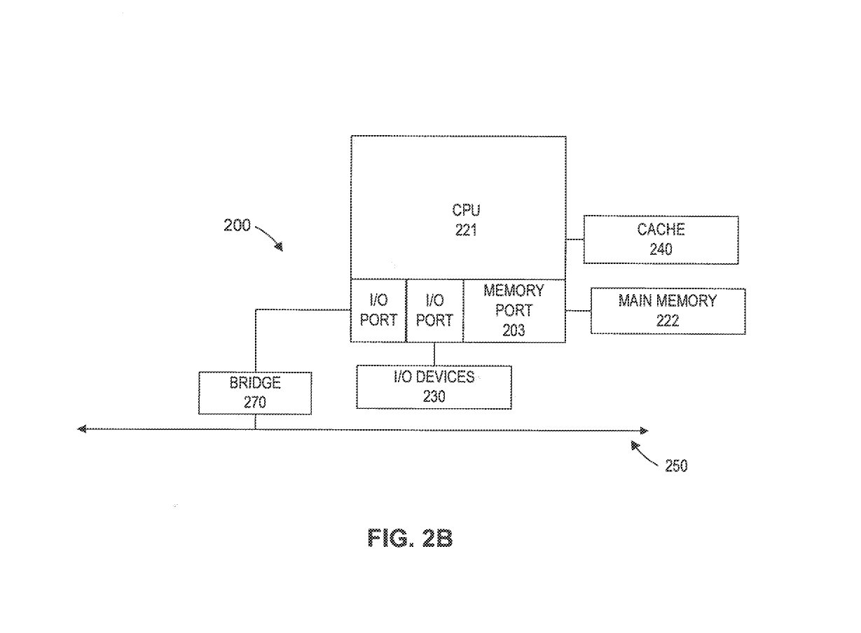

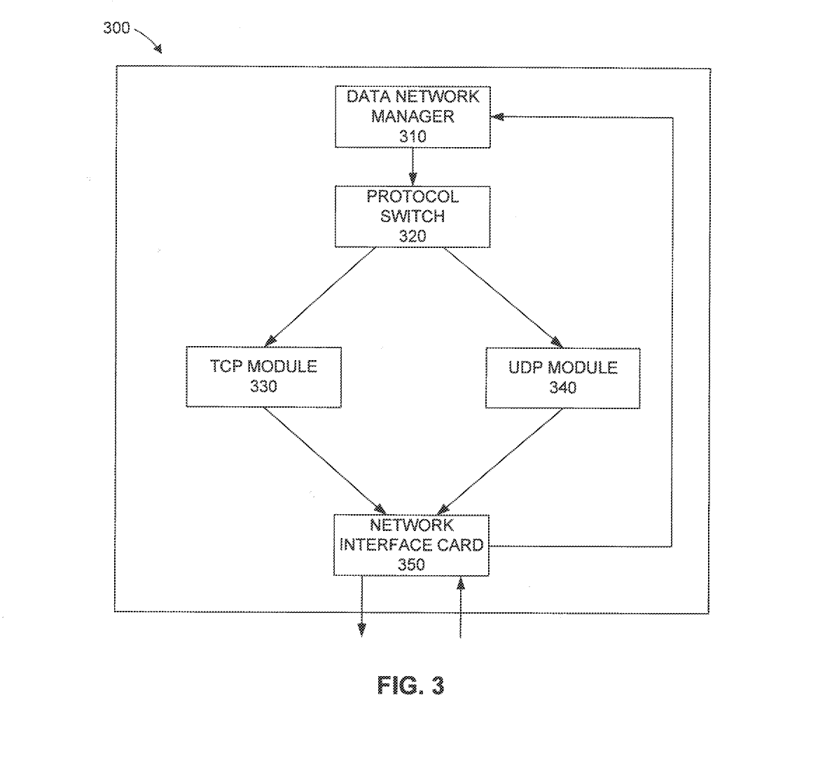

Appliances 108A and 108B and gateway 106 can be deployed as is, or executed on any type and form of computing device. Including any computer or networking device capable of communicating on any type and form of network described herein. As shown in FIGS. 2A-2B, each computing device 200 includes a central processing unit (CPU) 221 and a main memory 222. CPU 221 can be any logic circuitry that responds to and processes instructions fetched from the main memory 222. CPU 221 can be a single or multiple microprocessors, field-programmable gate arrays (FPGAs), or digital signal processors (DSPs) capable of executing particular sets of instructions stored in a memory (e.g., main memory 222) or cache (e.g., cache 240). The memory includes a nontransitory computer-readable medium, such as a flexible disk, a hard disk, a CD-ROM (compact disk read-only memory), MO (magneto-optical) drive, a DVD-ROM (digital versatile disk read-only memory), a DVD-RAM (digital versatile disk random-access memory), RAM, flash memory, register, cache, or a semiconductor memory. Main memory 222 can be one or more memory chips capable of storing data and allowing any storage location to be directly accessed by CPU 221. Main memory 222 can be any type of random access memory (RAM), or any other available memory chip capable of operating as described herein. In the exemplary embodiment shown in FIG. 2A, CPU 221 communicates with main memory 222 via a system bus 250. Computing device 200 can also include a visual display device 224 and an input/output (I/O) device 230 (e.g., a keyboard, mouse, or pointing device) connected through I/O controller 223, both of which communicate via system bus 250. Furthermore, I/O device 230 can also provide storage and/or an installation medium for the computing device 200. It should be appreciated that, in some embodiments, elements of computing device 200 can be correspond to hardware or used to implement software described throughout this specification. For example, network interface 218 can correspond with network interface card 350 (of FIG. 3).

FIG. 2B depicts an embodiment of an exemplary computing device 200 in which CPU 221 communicates directly with main memory 222 via a memory port 203. CPU 221 can communicate with a cache 240 via a secondary bus, sometimes referred to as a backside bus. In some other embodiments, CPU 221 can communicate with cache 240 via system bus 250. Cache 240 typically has a faster response time than main memory 222. In some embodiments, CPU 221 can communicate directly with I/O device 230 via an I/O port. In further embodiments, I/O device 230 can be a bridge 270 between system bus 250 and an external communication bus, such as a USB bus, an Apple Desktop Bus, an RS-432 serial connection, a SCSI bus, a FireWire bus, a FireWire 800 bus, an Ethernet bus, an AppleTalk bus, a Gigabit Ethernet bus, an Asynchronous Transfer Mode bus, a HIPPI bus, a Super HIPPI bus, a SerialPlus bus, a SCI/LAMP bus, a FibreChannel bus, or a Serial Attached small computer system interface bus.

As shown in FIG. 2A, computing device 200 can support any suitable installation device 216, such as a floppy disk drive for receiving floppy disks such as 3.5-inch, 5.25-inch disks or ZIP disks; a CD-ROM drive; a CD-R/RW drive; a DVD-ROM drive; tape drives of various formats; a USB device; a hard-drive; or any other device suitable for installing software and programs such as any client agent 220, or portion thereof. Computing device 200 can further comprise a storage device 228, such as one or more hard disk drives or redundant arrays of independent disks, for storing an operating system and other related software, and for storing application software programs such as any program related to client agent 220. Optionally, any of the installation devices 216 could also be used as storage device 228.

Furthermore, computing device 200 can include a network interface 218 to interface to a LAN, WAN, MAN, or the Internet through a variety of connections including, but not limited to, standard telephone lines, LAN or WAN links (e.g., 802.11, T1, T3, 56 kb, X.25), broadband connections (e.g., ISDN, Frame Relay, ATM), wireless connections, or some combination of any or all of the above. Network interface 218 can comprise a built-in network adapter, network interface card, PCMCIA network card, card bus network adapter, wireless network adapter, USB network adapter, modem or any other device suitable for interfacing computing device 200 to any type of network capable of communication and performing the operations described herein.

FIG. 3 is a block diagram of an exemplary computing device 300, consistent with embodiments of the present disclosure. In some embodiments, computing device 300 or portions thereof can be included in computing device 200. For example, various modules or connections shown in computing device 300 can be implemented as software or I/O devices 230 as described with respect to computing device 200. Exemplary computing device 300 illustrates an example configuration of various modules, which can be hardware, used to implement various systems and methods described herein. For example, exemplary computing device 300 can be used by a system to determine the amount of congestion over a particular connection implementing a TCP protocol, determine that the communication protocol should be switched to a UDP-based protocol, and then cause the switch to occur.

Exemplary computing device 300 can include a data network manager 310, a protocol switch 320 (which can receive data packets 360), a TCP connection 330, a UDP connection 340, and a network interface card 350. In various embodiments, exemplary computing device 300 can receive at network interface card 350 (which can correspond to network interface 218 or I/O devices 230 of FIGS. 2A-2B) data from an external device. In some embodiments, computing device 300 and the external device can have a session where data packets are being communicated. The data received by computing device 300 from an external device at network interface card 350 can be formatted using a variety of transportation protocols, such as TCP or UDP. After data is received by network interface card 350, in some embodiments, the data can be provided to data network manager 310.

Data network manager 310 is a module, which is a packaged functional hardware unit designed for use with other components or a part of a program that performs a particular function of related functions. Data network manager 310 can acquire the data from network interface card 350 and analyze that data to help determine whether a transport protocol switch should occur. For example, network interface card 350 can receive data from a network (e.g., network 104 or 110 of FIG. 1) and provide that information to data network manager 310. Data network manager 310 can determine characteristics (also referred to as attributes) of a network based on the information received from network interface card 350. Based on these network attributes, data network manager 310 can determine what type of transport protocol computing device 300 will send data packets 360 over based on the data received from network interface card 350. Network characteristics such as latency, noise, packet loss, and available bandwidth may be taken into consideration by data network manager 310 when data network manager 310 determines whether to cause a switch in transport protocols. For example, based on these characteristics, data network manager 310 can instruct protocol switch 320 to cause data packets 360 to be formatted using a TCP connection 330 or a UDP connection 340. In an example embodiment, if data network manager 310 determines that a UDP-based transport protocol should be used based on information received from network interface card 350 indicating that latency on a network (e.g., public network 104) is too high, data network manager 310 can instruct protocol switch 320 to change the transport protocol from a TCP-based protocol to a UDP-based protocol. Similarly, if data network manager 310 determines that a TCP-based protocol should be used based on information received from network interface card 350 indicating that packet loss on a network is too high, data network manager 310 can instruct protocol switch 320 to change the transport protocol from a TCP-based protocol to a UDP-based protocol.

As described above, a variety of information can be used to determine whether to switch from TCP to a UDP-based protocol. Such information can be based on conditions associated with a network, and can include, but is not limited to: available bandwidth, amount of loss (e.g., of data packets 360), latency, etc.

For example, if the bandwidth on a network is less than a particular threshold amount, a device can switch from one protocol to another. In various embodiments, a TCP protocol can switch to a UDP-based protocol, or an ICA protocol (over TCP) can switch to a UDP-based protocol such as LFP, etc.

Further, in some embodiments, if a network employing TCP is exhibiting a particular amount of loss (e.g., an amount of loss of packets above a particular threshold), a device can switch to a UDP-based protocol. As another example, if a network employing TCP exhibits a particular amount of latency (e.g., latency above a particular amount of time), a device can switch to a UDP-based protocol. It is contemplated that in some embodiments, a device can determine the latency or amount of loss using TCP while it is communicating over a UDP-based protocol. This can occur at particular time intervals, at the request of a user, continuously, etc. Thus, if it is determined that a network employing TCP exhibits less than a particular amount of latency and/or loss (e.g., less latency and/or loss than the same network was exhibiting at a previous time), computing device 300 can switch to a UDP-based protocol.

In various embodiments, protocols can be employed to prevent or lessen jitter/bounce when switching between protocols. For instance, in some embodiments a device can switch from a first transport protocol to a second transport protocol when a network exhibits conditions that indicate that the second protocol will not cause the device to switch back to the first protocol within a particular period of time (e.g., immediately, within a few seconds, etc.). By reducing bounce/jitter associated with switching protocols, a device can save time and resources.

It should be appreciated that, in some embodiments, protocol switch 320 can be included in data network manager 310. In some embodiments, protocol switch 320 can be included in data network manager 310. Data network manager 310 can instruct protocol switch 320 to direct data packets 360 to TCP connection 330 or UDP connection 340, or, in some embodiments, data network manager 310 can provide protocol switch 320 with information so protocol switch 320 can determine whether to direct data packets 360 to TCP connection 330 or UDP connection 340.

As shown in FIG. 3, in some embodiments, data packets 360 can be transmitted through protocol switch 320 before they are transmitted over a network. In addition or in the alternative, data packets 360 can be routed to TCP connection 330 or UDP connection 340 without traveling through protocol switch 320. As discussed above, protocol switch 320 can acquire information regarding what type of transport protocol to send data over, including TCP connection 330 or UDP connection 340 (which can be a UDP-based connection such as LFP). Based on the protocol determination, protocol switch can provide data packets 360 to either TCP connection 330 or UDP connection 340. In some embodiments, data packets 360 may be grouped together or be otherwise associated (e.g., have the same destination, be part of the same session). Protocol switch 320 can cause data packets 360 to switch between being transmitted via TCP connection 330 or UDP connection 340 in between groups of data packets 360, or in the middle of a group of data packets 360. For example, protocol switch 320 can switch transport protocols while computing device 300 is continuously communicating with another device (e.g., during a session).

In some embodiments, protocol switch 320 can instruct another device (e.g., a physical or virtual device) to route data packets 360 directly to either TCP connection 330 or UDP connection 340, such that the data packets 360 intended to be transmitted does not flow through protocol switch 320.

In some embodiments, TCP connection 330 and UDP connection 340 can be used to format data packets 360 according to a particular transport protocol. For example, data provided to TCP connection 330 can be formatted in a manner consistent with the standards associated with TCP (e.g., Request for Comments (RFC) 793). Moreover, data provided to UDP connection 340 can be formatted in a manner consistent with the standards associated with UDP (e.g., RFC 768).

After data is formatted based on a transport protocol, the data can be provided to network interface card 350 for transmission. It should be appreciated that network interface card 350 can be the same network interface card 350 used to receive information about the attributes of a particular network or channel, or it can be a different network interface card than the one used to receive the network characteristics that are subsequently used to determine whether to switch protocols. In any case, network interface card 350 can assist with monitoring network conditions and/or transmitting packets which are formatted based on network conditions.

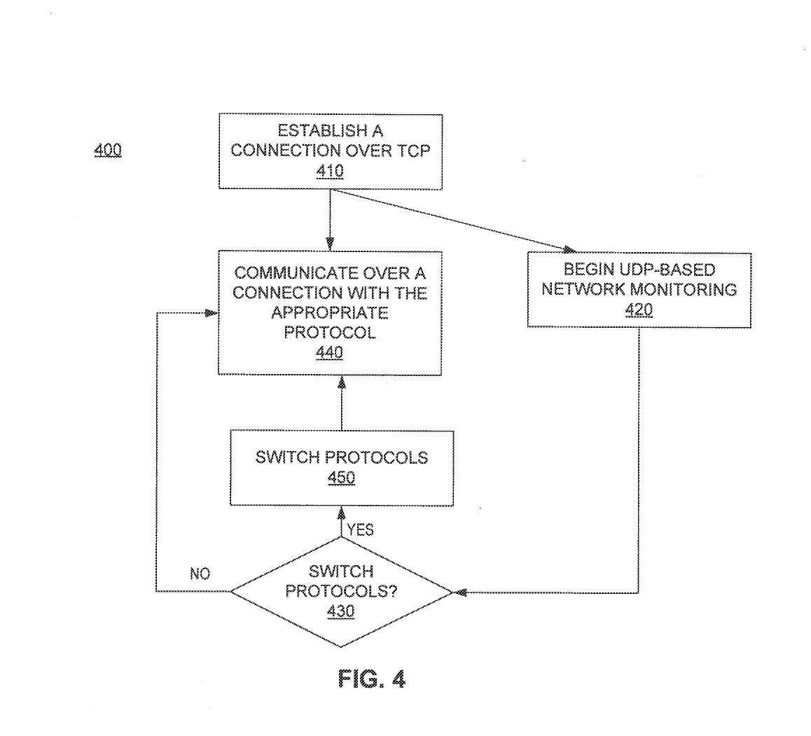

FIG. 4 is a flowchart representing an exemplary method 400 for dynamically switching between protocols, consistent with embodiments of the present disclosure. Referring to FIG. 4, it will readily be appreciated that the illustrated procedure can be altered to delete steps, modify steps, or include additional steps, as described below. Moreover, steps can be performed in a different order than shown in method 400, and/or in parallel. While the flowchart representing method 400 provides exemplary steps for a device (e.g., appliance 108 or client devices 102A-F of FIG. 1, computing device 200 of FIGS. 2A and 2B, computing device 300 of FIG. 3, etc.) to conduct dynamic protocol switching, it is appreciated that one or more other devices can conduct the dynamic protocol switching alone or in combination with the device.

At step 410, a connection is established over a network employing TCP. Although step 410 is not always required, it can be helpful to determine network characteristics as provided by a TCP connection. For example, a TCP connection (e.g., TCP connection 330) causes two devices to exchange packets over a network and inherently determines characteristics of that network (e.g., reliability and network congestion). As such, it can be desirable for a device to establish an initial connection that employs TCP, but it should be appreciated that either a TCP connection or a UDP connection can be used to determine network characteristics.

At step 420, a device begins to monitor a network using a UDP-based protocol, such as LFP (e.g., via data network manager 310 of FIG. 3). Monitoring with a UDP-based protocol can occur in parallel with step 440, which causes a device to communicate over a connection (e.g., TCP connection 330 or UDP connection 340 of FIG. 3) with an appropriate protocol. As such, in some embodiments, after a connection that employs TCP is established, a device can both communicate TCP as well as monitor network conditions with a UDP-based protocol. It should be appreciated that, in some embodiments, a device can monitor a network using TCP alternatively, or in addition to UDP. For example, in some embodiments a TCP-based connection can communicate with two or more devices to determine packet loss, latency, and other characteristics associated with a network.

While monitoring a network, a device can determine at step 430 whether or not to switch from TCP to a UDP-based protocol. As described above, a variety of information can be used to determine whether to switch from TCP to a UDP-based protocol. Such information can be based on conditions associated with a network, and can include, but is not limited to: available bandwidth, amount of loss (e.g., of packets), latency, etc.

For example, if the bandwidth on a network is less than a particular threshold amount, a device can switch from one protocol to another. In various embodiments, a TCP protocol can switch to a UDP-based protocol, or an ICA protocol (over TCP) can switch to a UDP-based protocol such as LFP, etc.

Further, in some embodiments, if a network employing TCP is exhibiting a particular amount of loss (e.g., an amount of loss of packets above a particular threshold), a device can switch to a UDP-based protocol. As another example, if a network employing TCP exhibits a particular amount of latency (e.g., latency above a particular amount of time), a device can switch to a UDP-based protocol. It is contemplated that in some embodiments, a device can determine the latency or amount of loss using TCP while it is communicating over a UDP-based protocol. This can occur at particular time intervals, at the request of a user, continuously, etc. Thus, if it is determined that a network employing TCP exhibits less than a particular amount of latency and/or loss (e.g., less latency and/or loss than the same network was exhibiting at a previous time), computing device 300 can switch to a UDP-based protocol.

In various embodiments, protocols can be employed to prevent or lessen jitter/bounce when switching between protocols. For instance, in some embodiments a device can switch from a first transport protocol to a second transport protocol when a network exhibits conditions that indicate that the second protocol will not cause the device to switch back to the first protocol within a particular period of time (e.g., immediately, within a few seconds, etc.). By reducing bounce/jitter associated with switching protocols, a device can save time and resources.

If a determination is made that a device should switch protocols, at step 450 the device switches protocols to communicate over a network (e.g., to TCP or to a UDP-based protocol such as LFP). At step 440, a device can communicate over a connection (e.g., network, channel, etc.) with an appropriate protocol. In some embodiments, this protocol can be a protocol that a device switched to using information received from monitoring a network with a UDP-based protocol as in step 420.

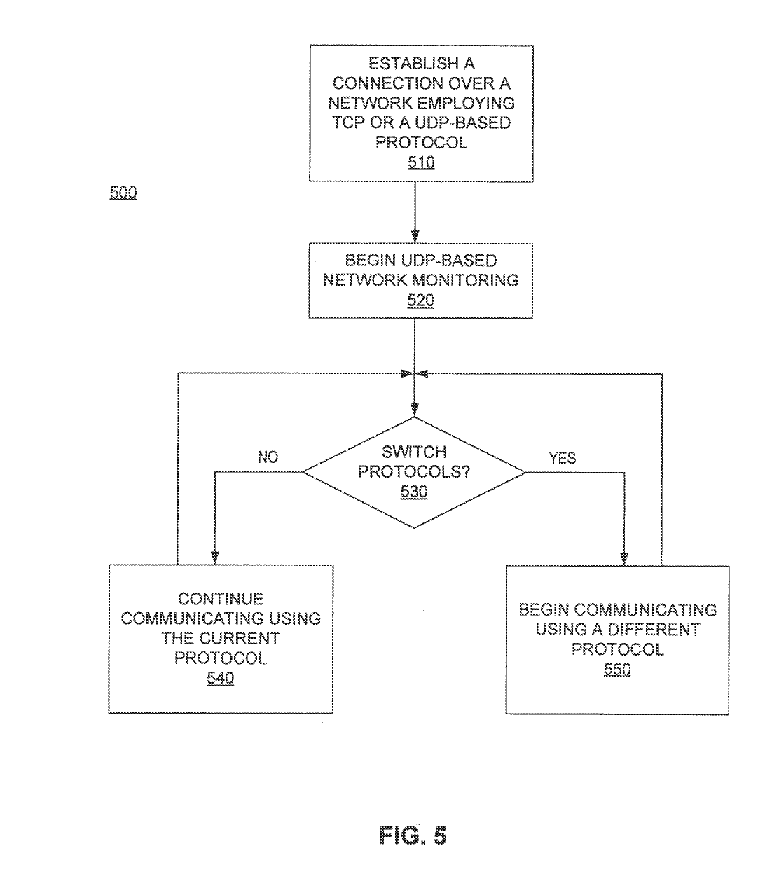

FIG. 5 is a flowchart representing an exemplary method of dynamic protocol switching, consistent with embodiments of the present disclosure. At step 510, a device establishes a connection over either network employing TCP or a UDP-based protocol. For example, one or more of TCP connection 330 and/or UDP connection 340 (of FIG. 3) can be used to connect to a device over a network such as network 104 (of FIG. 1). Regardless of the transport protocol established at step 510, at step 520 a device can begin monitoring a network with a UDP-based protocol, although it should be appreciated that a TCP-based protocol can be used to monitor network conditions. In some embodiments, monitoring can be performed using LFP as described above. Devices communicating with one another can be configured to send information associated with the network characteristics of a network they are communicating over using packets sent over a UDP protocol. It should be appreciated that in some embodiments, as described below, one device monitoring network conditions and another device communicating over the network can be different devices.

At step 530, a determination is made as to whether to switch a transport protocol that a device is currently communicating over. For example, data network manager 310 can determine whether a different transport protocol should be used based on network characteristics and cause protocol switch 320 to cause data packets 360 to be formatted using a TCP connection 330 or a UDP connection 340 (all of FIG. 3). In various embodiments, a user can create a set of rules, or otherwise predefine a set of conditions, which can be compared with network characteristics and be used to determine whether a transport protocol should be switched. If a determination is made that the transport protocol should not be switched, at step 540 a device can continue to communicate using the current protocol. If a determination is made that the protocol should be switched, at step 550 a device will begin communicating using a different protocol. Regardless of whether a switch occurs or a device continues to communicate using the transport protocol it is currently communicating over, a device may continue to monitor network conditions and determine whether to switch protocols at step 530.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

What is claimed is:

1. An appliance comprising:
a network interface card configured to communicate a set of data packets to a device over a network;
at least one memory configured to store a set of instructions; and
one or more processors configured to execute the set of instructions to cause the appliance to:
establish a connection to the device over the network, wherein the connection employs a first transport protocol and involves communicating some data packets of the set of data packets over the connection;
monitor network characteristics between the appliance and the device; and
in response to monitoring the network characteristics, switch protocols for communicating other data packets of the set of data packets over a connection to the device, wherein the switch of protocols involves the communication of the other data packets using a second transport protocol.

2. The appliance of claim 1, wherein the first transport protocol or the second transport protocol is a Lightweight Framebuffer Protocol (LFP).

3. The appliance of claim 1, wherein the one or more processors configured to execute the set of instructions further cause the appliance to:
in response to determining that the appliance is communicating over the second transport protocol and that the network characteristics meet a criteria, switch transport protocols to cause the appliance to communicate over the first transport protocol.

4. The appliance of claim 1, wherein the one or more processors configured to execute the set of instructions further cause the appliance to:
receive data associated with the network characteristics based at least in part on a second connection employing a user datagram protocol (UDP)-based protocol.

5. The appliance of claim 4, wherein the UDP-based protocol is LFP.

6. The appliance of claim 1, wherein the one or more processors configured to execute the set of instructions further cause the appliance to:
receive input indicating whether to switch protocols based on input from a user.

7. The appliance of claim 1, wherein monitoring the network characteristics includes determining whether the appliance will be switch back to communicating using the first transport protocol within a particular period of time.

8. A method for communicating a set of data packets to a device over a network, the method being performed by one or more processors and comprising:
establishing a connection to the device over the network, wherein the connection employs a first transport protocol and involves communicating some data packets of the set of data packets over the connection;
monitoring characteristics associated with the network; and
in response to monitoring the characteristics associated with the network, switching protocols for communicating other data packets of the set of data packets over a connection to the device, wherein the switch of protocols involves the communication of the other data packets using a second transport protocol.

9. The method of claim 8, wherein the first transport protocol or the second transport protocol is a Lightweight Framebuffer Protocol (LFP).

10. The method of claim 8, further comprising:
in response to determining that the communication is occurring over the second transport protocol and that the characteristics associated with the network meet a particular criteria, switching transport protocols to cause the communication to occur over the first transport protocol.

11. The method of claim 8, further comprising:
receiving data associated with the characteristics associated with the network based at least in part on a second connection employing a UDP-based protocol.

12. The method of claim 11, wherein the UDP-based protocol is LFP.

13. The method of claim 8, further comprising:
receiving input indicating whether to switch protocols based on input from a user.

14. The method of claim 8, wherein monitoring the characteristics associated with the network includes determining whether a switch back to communicating using the first transport protocol will occur within a particular period of time.

15. A nontransitory computer readable storage medium storing a set of instructions that are executable by at least one processor of a computer, to cause the computer to perform a method for communicating a set of data packets to a device over a network, the method comprising:
establishing a connection to the device over the network, wherein the connection employs a first transport protocol and involves communicating some data packets of the set of data packets over the connection;
monitoring characteristics associated with the network; and
in response to monitoring the characteristics associated with the network, switching protocols for communicating other data packets of the set of data packets over a connection to the device, wherein the switch of protocols involves the communication of the other data packets using a second transport protocol.

16. The nontransitory computer readable storage medium of claim 15, wherein the first transport protocol or the second transport protocol is a Lightweight Framebuffer Protocol (LFP).

17. The nontransitory computer readable storage medium of claim 15, wherein the method further comprises:
in response to determining that the communication is occurring over the second transport protocol and that the characteristics associated with the network meet a particular criteria, switching transport protocols to cause the communication to occur over the first transport protocol.

18. The nontransitory computer readable storage medium of claim 15, wherein the method further comprises:
receiving data associated with the characteristics associated with the network based at least in part on a second connection employing a UDP-based protocol.

19. The nontransitory computer readable storage medium of claim 17, wherein the UDP-based protocol is LFP.

20. The nontransitory computer readable storage medium of claim 15, wherein monitoring the characteristics associated with the network includes determining whether a switch back to communicating using the first transport protocol will occur within a particular period of time.
